(19) United States
(12) Patent Application Publication
(10) Pub. No.: US 2020/0391057 A1
(43) Pub. Date: Dec. 17, 2020

(54) Respirator Mask with Eyewear Interface

(71) Applicant: SCOTT TECHNOLOGIES, INC., Monroe, NC (US)

(72) Inventors: Darin Kyle Thompson, Huntersville, NC (US); Edward Powers Simmonds, Indian Trail, NC (US); Graham Peter Wilson, Flintshire (GB); Carl Estcourt Tucker, Lincolnshire (GB)

(21) Appl. No.: 15/769,833

(22) PCT Filed: Oct. 21, 2016
(86) PCT No.: PCT/US2016/058086

§ 371 Date: Apr. 20, 2018

Related U.S. Application Data
(60) Provisional application No. 62/244,911, filed on Oct. 22, 2015.

(51) Int. Cl. A62B 18/08; A41D 13/11; A62B 23/02; A62B 18/02

(52) U.S. Cl. CPC A62B 18/082; A62B 18/025; A62B 23/02; A41D 13/1184

(57) ABSTRACT

A respirator including an oronasal mask. The oronasal mask has a first portion configured to cover a user's mouth and a second portion configured to cover a user's nose. The second portion includes an eyewear interface. The eyewear interface includes a first side defining a first concavity and a second side opposite the first side, the second side defining a second concavity. The first concavity and the second concavity being configured to receive a nose member of an eyewear.

### TECHNICAL FIELD

The present invention relates to a respirator mask having an eyewear interface.

### BACKGROUND

Respirator masks are used in environments where individuals are exposed to hazardous materials, such as gases, vapors, aerosols (e.g., dusts, mists, and/or biological agents), and/or the like. Respirator masks come in a large variety of types and sizes, ranging from cheaper, disposable masks to higher cost, reusable masks that include replaceable filtration cartridges. Some respirator masks (e.g., oronasal masks or half-masks) cover the mouth and nose of the user but do not cover the user's eyes. Accordingly, eyewear (e.g., goggles, safety glasses, sunglasses, and/or corrective eyeglasses) is often worn in combination with a respirator mask to protect the user's eyes.

But, some known respirator masks do not fit together satisfactorily with one or more types of eyewear. Such an unsatisfactory fit between the respirator mask and the eyewear, for example, may be uncomfortable (e.g., may cause the eyewear to rest on the user's face in an uncomfortable manner), may prevent the eyewear from sealing with the user's face, may impair the user's vision (e.g., may cause the eyewear to rest on the user's face in a position wherein the eyewear intrudes on the user's field of vision), and/or the like. For example, the eyewear may rest relatively high on the user's face such that the lower frame of the eyewear obstructs the user's field of vision. Accordingly, a user may choose not to wear the eyewear, which may result in injury to the user's eyes. If a user chooses to wear eyewear, an unsatisfactory fit between the eyewear and the respirator mask may impair the user's vision and/or may cause injury to the user's eyes because of the lack of an adequate seal between the eyewear and the user's face.

Some known respirator masks include a discrete spectacle frame mount that is attached to a body of the mask. But, such spectacle frame mounts may be expensive, may be difficult to attach to the mask body, may be susceptible to failure (e.g., may detach from the mask body), and/or may only be compatible with a particular type of eyewear such that the respirator mask does not accommodate other types of eyewear.

### SUMMARY

The present invention advantageously provides a respirator that can accommodate simultaneous use with eyewear. In one embodiment a respirator includes an oronasal mask. The oronasal mask has a first portion configured to cover a user's mouth and a second portion configured to cover a user's nose. The second portion includes an eyewear interface. The eyewear interface includes a first side defining a first concavity and a second side opposite the first side, the second side defining a second concavity. The first concavity and the second concavity being configured to receive a nose member of corresponding eyewear.

In another aspect of this embodiment, the eyewear interface defines a nose bridge receiving portion disposed between the first concavity and the second cavity, the nose bridge receiving portion being configured to receive a nose bridge of the corresponding eyewear.

In another aspect of this embodiment, the nose bridge receiving portion is a recess.

In another aspect of this embodiment, the nose bridge of the corresponding eyewear rests within the recess when corresponding eyewear is removably coupled to the oronasal mask.

In another aspect of this embodiment, the recess is arcuate in shape along its length.

In another aspect of this embodiment, the first concavity, the second concavity, and the recess cooperate to define a continuous channel.

In another aspect of this embodiment, the oronasal mask includes a removable filter.

In another aspect of this embodiment, the first concavity and the second concavity are configured to receive the nose members of safety goggles and safety glasses.

In another aspect of this embodiment, the first concavity is entirely disposed on the first side and the second concavity is entirely disposed on the second side.

In another aspect of this embodiment, when corresponding eyewear is worn by a user when wearing the respirator, the nose member of corresponding eyewear presses against the first concavity and the second cavity.

In another aspect of this embodiment, the first concavity and the second concavity extend underneath the nose member when corresponding eyewear is removably coupled to the oronasal mask.

In another embodiment, the respirator includes an oronasal mask having a first portion configured to cover a user's mouth and a second portion configured to cover and substantially contour a user's nose. The second portion includes an eyewear interface including a first side corresponding to a first side of a user's nose, a second side opposite the first side, and a nose bridge receiving portion disposed there between. The first side defines a first concavity and the second side defining a second concavity, the first concavity and the second concavity are disposed opposite from each other and are configured to receive a nose bridge and a nose member of at least one of safety goggles and safety glasses.

In another aspect of this embodiment, the first concavity is entirely disposed on the first side and the second concavity is entirely disposed on the second side.

In another aspect of this embodiment, when corresponding eyewear having a nose member is worn by the user when wearing the respirator, the nose member presses against the first concavity and the second concavity.

In another aspect of this embodiment, the first concavity and the second concavity extend underneath the nose member when corresponding eyewear is worn by the user when wearing the respirator.

In another aspect of this embodiment, the nose bridge receiving portion is a recess.

In another aspect of this embodiment, the nose bridge of the corresponding eyewear rests within the recess when corresponding eyewear is worn by the user when wearing the respirator.

In another aspect of this embodiment, the recess is arcuate in shape.

In another aspect of this embodiment, the oronasal mask includes a removable filter.

In yet another embodiment, the respirator includes an oronasal mask having a first portion configured to cover a user's mouth, a second portion configured to cover and substantially contour a user's nose, and a removable filter. The second portion includes an eyewear interface including a first side corresponding to a first side of a user's nose, a second side opposite the first side, and a nose bridge receiving portion disposed there between, the nose bridge receiving portion defines an arcuate recess. The first side defines a first concavity and the second side defining a second concavity, the first concavity and the second concavity being separated from each other. When safety goggles having a nose bridge and a nose member are worn by a user when wearing the respirator the nose member presses against the first concavity and the second concavity, and the first concavity and the second cavity extend underneath the nose member, and the nose bridge rests within the arcuate recess of the nose bridge receiving portion.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a front perspective view of an embodiment of an oronasal mask for providing respiratory protection;

FIG. 2 is side view of the oronasal mask shown in FIG. 1;

FIG. 3 is a perspective view illustrating the oronasal mask shown in FIG. 1-2 with an exemplary pair of safety glasses fitted thereto;

FIG. 4 is an enlarged perspective view of FIG. 3;

FIG. 5 is a perspective view illustrating the respirator mask shown in FIGS. 1-4 as worn by a user in combination with the safety glasses shown in FIGS. 3-4;

FIG. 6 is a perspective view illustrating the respirator mask shown in FIGS. 1-5 as worn by a user in combination with an exemplary pair of goggles; and

FIG. 7 is a front perspective view of another embodiment of an oronasal mask for providing respirator protection with a nose bridge receiving portion.

### DETAILED DESCRIPTION

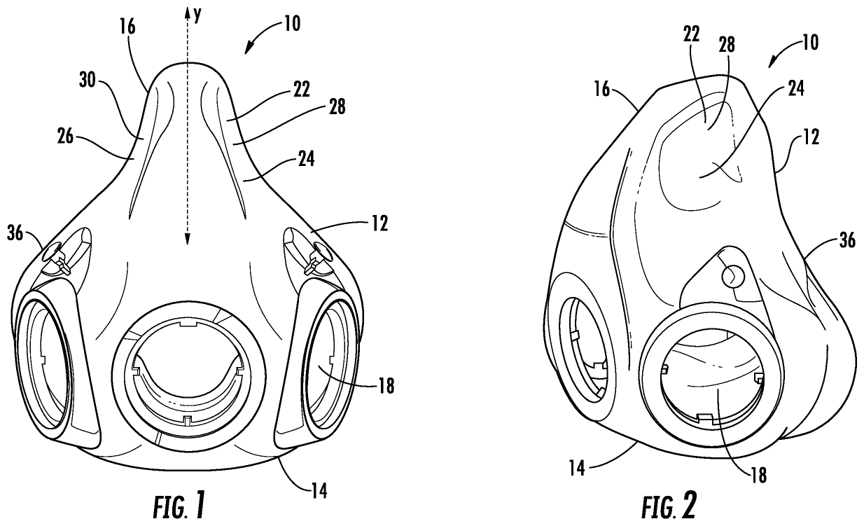

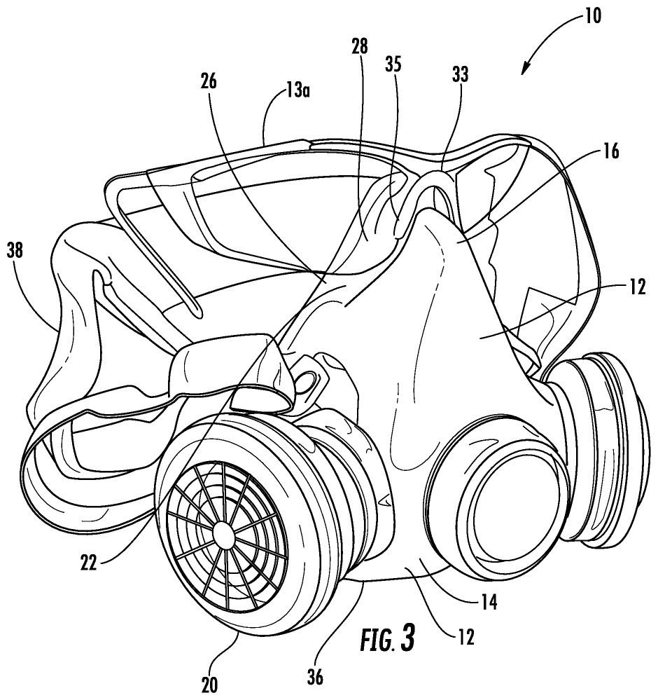

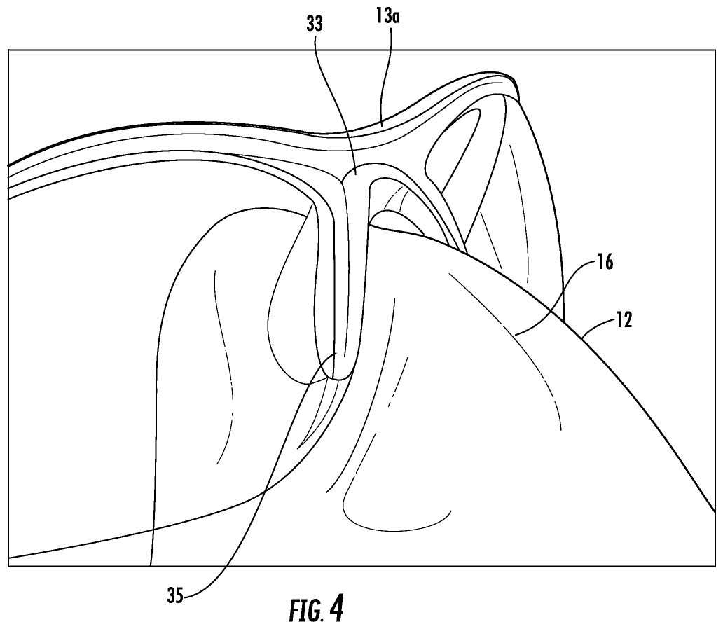

Referring now to the drawings in which like reference designators refer to like elements, there is shown in FIGS. 1-2 and exemplary respirator constructed in accordance with the principles of the present application and designated generally as “10.” The respirator 10 is configured to be worn by a user in environments where the user is exposed to hazardous materials, such as, but not limited to, gases, vapors, aerosols (e.g., dusts, mists, and/or biological agents), and/or the like. The respirator 10 includes an oronasal mask 12 that is configured to cover the nose and mouth of the user, but not the user's eyes. Accordingly, the oronasal mask 12 is configured such that it may be worn in combination with any type of eyewear 13 (shown in FIG. 3), including but not limited to, goggles, safety glasses, sunglasses, corrective eyeglasses, and the like.

The oronasal mask 12 may be fabricated from one or more materials that lend flexibility to the oronasal mask 12. In some embodiments, the oronasal mask 12 is sufficiently flexible such that the body 12 is configured to conform to the size, shape, and/or the like of the eyewear 13, as will be described below. Examples of materials that may be used to fabricate the oronasal mask 12 with at least some flexibility include, but are not limited to, thermosets, thermoplastics, elastomers, thermoplastic elastomers, cushioning and/or dampening materials, shape memory materials, and/or the like.

The oronasal mask 12 includes a first portion 14 configured to cover a user's mouth and a second portion 16 configured to cover a user's nose. In an exemplary configuration, the first portion 14 includes at least one opening 18 sized and configured to releasably receive one or more air filters 20 (shown in FIG. 3) for filtering air entering the oronasal mask 12 as the user breathes. In the configuration shown in FIGS. 1 and 2 multiple air filters 20 are included and may be removable and replaceable. The air filters 20 may include a cartridge, a valve, an air hose, or the like and may define different shaped in sizes. Optionally, a speech module (not shown) or other devices may be received with the at least one opening 18.

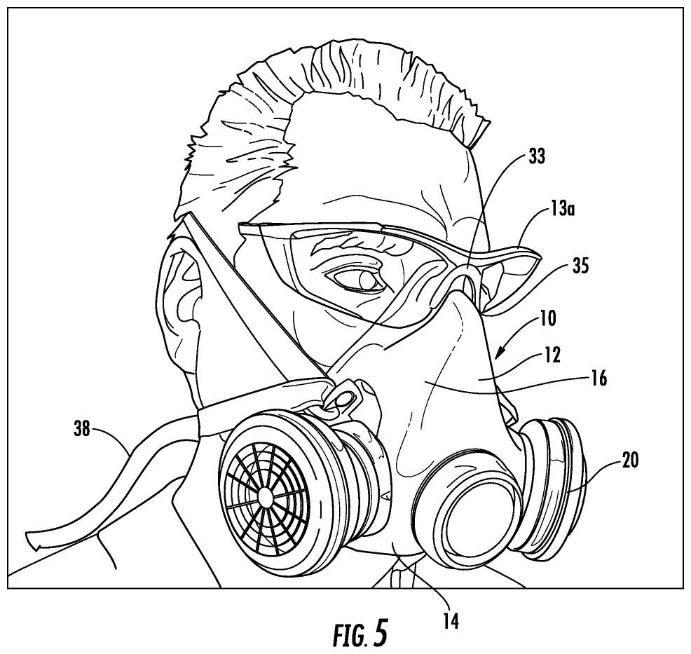

The second portion 16 is configured to contour the user's nose and further includes an eyewear interface 22 that facilitates the placement and fit of eyewear when worn when the oronasal mask 12. In particular, the second portion 16 may include a first side 24 and a second side 26 opposite the first side 24, which may cooperate to define the boundaries of the user's nose. In an exemplary configuration the second portion 16 defines a longitudinal axis “y” (shown in FIG. 1), and the first side 24 and the second side 26 are symmetric about a longitudinal axis “y” defined by the second portion 16. The eyewear interface 22 includes a first concavity 28 on the first side 24 and a second concavity 30 on the second side 26. In one configuration, the first concavity 28 and the second concavity 30 are pockets. The first concavity 28 and the second concavity 30 may be entirely disposed on their respective first side 24 or second side 26 or may alternatively extend into a nose bridge receiving portion 32 (shown in FIG. 7) configured to receive a nose bridge 33 (shown in FIG. 3) of respective eyewear 13 described in more detail below. The first concavity 28 and the second concavity 30 are configured to receive corresponding nose members 35 (shown in FIG. 3) of various types of eyewear 13 worn by the user in combination with the oronasal mask 12. The nose member 35 is a component of the eyewear 13 configured to be in contact with the sides of the user's nose. As shown in FIG. 4, the nose member 35 includes one portion to contact one side of the user's nose and a second contact to contact the opposite side of the user's nose. In other configurations, the nose member is a single component in contact with both sides of the user's nose. The nose bridge 33 either connects the two portions of the nose member 35 or is formed as part of the nose member 35, depending on the type of eyewear 13.

As shown in FIGS. 1 and 2, the first concavity 28 and the second concavity 30 are integrally formed with a single, unitary construction with the oronasal mask 12. In other embodiments, the eyewear interface 22 and its corresponding first concavity 28 and second concavity 30 are discrete components that are affixed, either permanently or removably, to the oronasal mask 12. Although two concavities 28 and 30 are shown in FIGS. 1 and 2, the eyewear interface 22 may include any number concavities for receiving any number of nose members 35. When a user wears eyewear 13 in combination with the oronasal mask 12, the nose member 35 of the eyewear 13 nests within the first concavity 28 and the second concavity 30 to facilitate enabling the eyewear 13 to rest on the user's face in a satisfactory position (e.g., a position intended by the manufacturer, a position that is comfortable for the user, a position that does not impair the user's vision, a position wherein the eyewear is sealed to the user's face, and/or the like) when worn in combination with the oronasal mask 12. The various design parameters, including but not limited to, the dimensions, the shape, the orientation, the position, the location, and/or the like of the first concavity 28 and the second concavity 30 may be selected to facilitate enabling the eyewear 13 to rest on the user's face in a satisfactory position when worn in combination with the oronasal mask 12.

Continuing to refer to FIGS. 1-2, the oronasal mask 12 may include a sealing area 36 that is configured to seal against the user's face to thereby seal the oronasal mask 12 to the user's face. In the illustrated embodiment, the sealing area 36 of the oronasal mask 12 may include one or more flexible lips or alternatively may include any other structure, such as, but not limited to, a gasket, a cushion, and/or the like. The sealing area 36 may be integrally formed as a single, unitary structure with the perimeter of the oronasal mask 12 or alternative may be discrete component that is attached to the oronasal mask 12. Optionally, the sealing area 36 is defined by a portion of the one or more filters 20 as is commonly included in many disposable respirator masks wherein the mask is fabricated from a filter material. In other embodiments, the structure of the sealing area 36 may include a reusable discrete molded member that is attached to the oronasal mask 12.

Referring now to FIG. 3, the mask 10 may include a harness 38 configured to hold the oronasal mask 12 on the user's face and thereby hold the oronasal mask 12 in position over the user's nose and mouth. In the illustrated embodiment, the harness 38 includes a plurality of straps 40 that are attached to the oronasal mask 12 and wrap around the user's head. The harness 38 may be reusable and disposable. The harness 38 is optionally fabricated using materials that are relatively easy to sterilize with relatively common sterilization methods.

Continuing to refer to FIG. 3, the eyewear interface 22 facilitates improving the fit between the oronasal mask 12 and the eyewear 13. For example, by enabling the eyewear 13 to rest on the user's face in a satisfactory position, the eyewear 13 interface 22 may reduce or eliminate discomfort caused by wearing the eyewear 13 in combination with the oronasal mask 12, may prevent the eyewear 13 and/or the oronasal mask 12 from impairing the user's vision (e.g., may prevent the eyewear and/or the oronasal mask 12 from intruding on the user's field of vision), may enable the eyewear 13 to seal with the user's face, and/or may seal with the eyewear to provide a portion of a seal between the eyewear 13 and the user's face. The eyewear interface 22 may reduce or eliminate injury to the user's eyes, for example by increasing the likelihood that the user will wear the eyewear and/or by enabling the eyewear to rest on the user's face in a satisfactory position that protects the user's eyes. The eyewear interface 22 may be configured to accommodate a variety (e.g., two or more) of different types of eyewear. For example, first concavity 28 and the second concavity 30 may be configured to receive nose members 35 of two or more different types of eyewear 13, such as, but not limited to goggles, safety glasses, corrective eyeglasses, sunglasses, and/or the like.

For example, FIGS. 3 and 4 illustrate an embodiment of the oronasal mask 12 with an exemplary pair of safety glasses 13a fitted thereto, and FIG. 5 illustrates the oronasal mask 12 as worn by a user in combination with the safety glasses 13a. As shown in FIGS. 3-5, the nose bridge receiving portion 32 may define a concavity or a recess sized to receive the corresponding nose bridge 33 of the safety glasses 13a such that the nose bridge 33 is nested, pressed against, or is otherwise received within the nose bridge receiving portion 32. In one configuration, the nose bridge receiving portion 32 defines an arcuate recess along its longitudinal length to substantially conform to the nose bridge 33 of corresponding eyewear 13. Similarly, the first concavity 28 and the second concavity 30 may define a recess sized to receive corresponding nose member 35. In such a configuration, a portion the second portion 16 may extend underneath the corresponding eyewear 13.

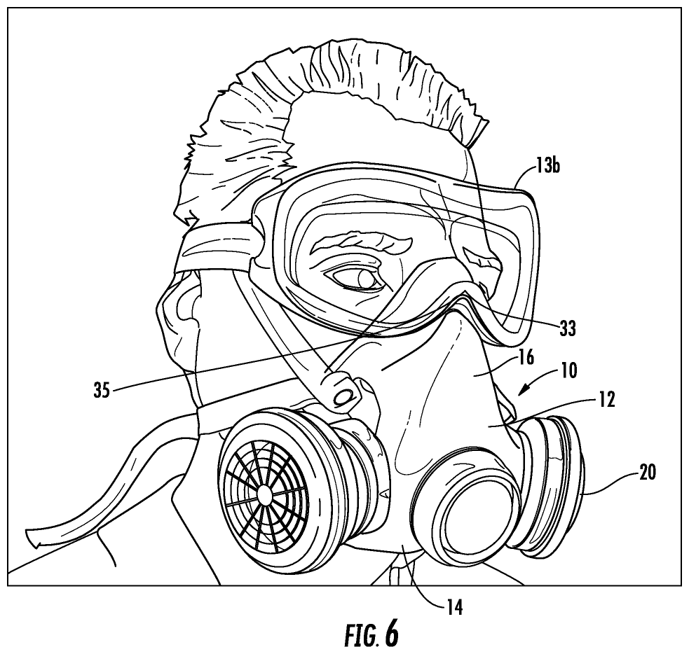

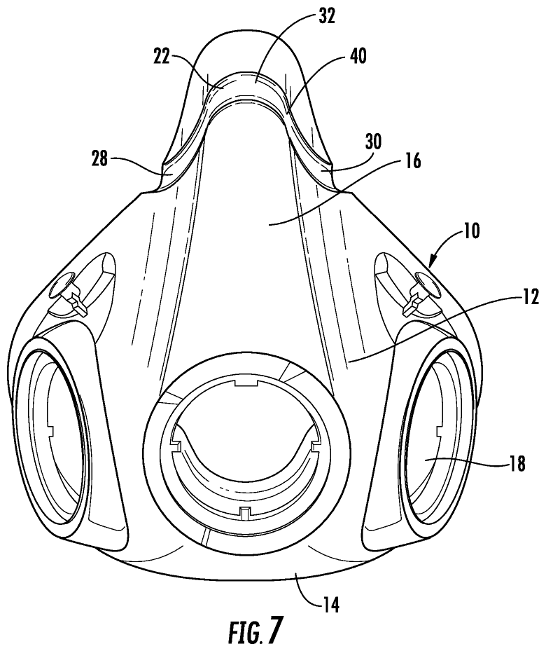

Now referring to FIG. 6, which illustrates oronasal mask 12 as worn by a user in combination with an exemplary pair of goggles 13b. A corresponding nose member 35 is received (i.e., nested) within the corresponding first concavity 28 and the second concavity 30 of the eyewear interface 22 such that nose bridge 33 of the goggles 13b rests on the nose bridge receiving portion 32. In such a configuration, the first concavity 28 and the second concavity 30 may extend underneath the nose member 35.

Now referring to FIG. 7, in another embodiment, the first concavity 28, the second concavity 30, and the nose bridge receiving portion 32 define a continuous channel 40. In such a configuration, the nose member 35 and the nose bridge 33 may be friction fit or nested within the channel 40 for a tight fit that keeps the node bridge 33 in place.

In one embodiment a respirator (10) includes an oronasal mask (12), the oronasal mask (12) having a first portion (14) configured to cover a user's mouth and a second portion (16) configured to cover a user's nose; the second portion (16) including an eyewear interface (22), the eyewear interface including: a first side (24) defining a first concavity (26); and a second side (28) opposite the first side, the second side (28) defining a second concavity (3); and the first concavity (28) and the second concavity (30) being configured to receive a nose member (35) of corresponding eyewear (13).

In another aspect of this embodiment, the eyewear interface (22) defines a nose bridge receiving portion (32) disposed between the first concavity (26) and the second concavity (28), the nose bridge receiving portion (32) being configured to receive a nose bridge (33) of the corresponding eyewear (13).

In another aspect of this embodiment, the nose bridge receiving portion (32) is a recess.

In another aspect of this embodiment, the nose bridge (33) of the corresponding eyewear (13) rests within the recess when corresponding eyewear (13) is removably coupled to the oronasal mask (12).

In another aspect of this embodiment, the recess is arcuate in shape along its length.

In another aspect of this embodiment, the first concavity (28), the second concavity (30), and the recess cooperate to define a continuous channel (40).

In another aspect of this embodiment, the oronasal mask (12) includes a removable filter (20).

In another aspect of this embodiment, the first concavity (28) and the second concavity (30) are configured to receive the nose member (35) of safety goggles (13b) and safety glasses (13a).

In another aspect of this embodiment, the first concavity (28) is entirely disposed on the first side (24) and the second concavity (30) is entirely disposed on the second side (26).

In another aspect of this embodiment, when corresponding eyewear (13) is worn by a user when wearing the respirator, the nose member (35) of corresponding eyewear (13) presses against the first concavity (28) and the second cavity (30).

In another aspect of this embodiment, the first concavity (28) and the second concavity (30) extend underneath the nose member (35) when corresponding eyewear (23) is removably coupled to the oronasal mask (12).

In another embodiment, the respirator includes a respirator (10) an oronasal mask (12), the oronasal mask (12) having a first portion (14) configured to cover a user's mouth and a second portion (16) configured to cover and substantially contour a user's nose; the second portion (16) including an eyewear interface (22), the eyewear interface (22) including a first side (24) corresponding to a first side of a user's nose, a second side (26) opposite the first side, and a nose bridge receiving portion (32) disposed there between; and the first side (24) defining a first concavity (28) and the second side (26) defining a second concavity (30), the first concavity (28) and the second concavity (30) are disposed opposite from each other and are configured to receive a nose bridge (33) and a nose member (35) of at least one of safety goggles (13b) and safety glasses (13a).

In another aspect of this embodiment, the first concavity (28) is entirely disposed on the first side (24) and the second concavity (30) is entirely disposed on the second side (26).

In another aspect of this embodiment, when corresponding eyewear (13) having a nose member (35) is worn by the user when wearing the respirator, the nose member (35) presses against the first concavity (28) and the second concavity (30).

In another aspect of this embodiment, the first concavity (28) and the second concavity (30) extend underneath the nose member (35) when corresponding eyewear (33) is worn by the user when wearing the respirator (10).

In another aspect of this embodiment, the nose bridge receiving portion (32) is a recess.

In another aspect of this embodiment, the nose bridge (33) of the corresponding eyewear (13) rests within the recess when corresponding eyewear is worn by the user when wearing the respirator (10).

In another aspect of this embodiment, the recess is arcuate in shape.

In another aspect of this embodiment, the oronasal mask (12) includes a removable filter (20).

In yet another embodiment, the respirator (1) includes an oronasal mask (12), the oronasal mask (12) having a first portion (14) configured to cover a user's mouth, a second portion (16) configured to cover and substantially contour a user's nose, and a removable filter (20); the second portion (16) including an eyewear interface (22), the eyewear interface (22) including a first side (24) corresponding to a first side of a user's nose, a second side (28) opposite the first side (24), and a nose bridge receiving portion disposed (32) there between, the nose bridge receiving portion (32) defining an arcuate recess; the first side (24) defining a first concavity (28) and the second side (26) defining a second concavity (30), the first concavity (28) and the second concavity (30) being separated from each other; and when safety goggles (13b) having a nose bridge (33) and a nose member (35) are worn by a user when wearing the respirator: the nose member (35) presses against the first concavity (28) and the second concavity (30), and the first concavity (28) and the second cavity (30) extend underneath the nose member (35); and the nose bridge (33) rests within the arcuate recess of the nose bridge receiving portion (32).

Other embodiments may include:

### Embodiment 1

A respiratory mask comprising:

a body configured to cover a nose and a mouth of a user, the body having an interior side and an opposite exterior side, the body comprising a nose area configured to receive the nose of the user therein, the nose area comprising an eyewear interface feature that include concave segments of the exterior side that extend along opposite sides of the nose area, the concave segments defining pockets that are configured to receive corresponding nose members of eyewear that is worn by the user in combination with the respiratory mask.

### Embodiment 2

The respiratory mask of Embodiment 1, wherein the concave segments of the exterior side of the body are integrally formed with a single, unitary construction with the mask body.

### Embodiment 3

The respiratory mask of Embodiment 1, wherein the nose area of the body is configured to conform to at least one of a size or a shape of a nose recess of the eyewear.

### Embodiment 4

The respiratory mask of Embodiment 1, wherein the body is configured to conform to at least one of a size or a shape of the nose members of the eyewear at the corresponding concave segments.

### Embodiment 5

The respiratory mask of Embodiment 1, wherein the pockets defined by the concave segments of the exterior side are configured to receive nose members of at least one of goggles, safety glasses, corrective eyeglasses, or sunglasses.

### Embodiment 6

The respiratory mask of Embodiment 1, wherein the pockets defined by the concave segments of the exterior side are configured to receive nose members of at least two different types of eyewear.

### Embodiment 7

The respiratory mask of Embodiment 1, wherein the nose area of the body is configured to form a seal with a nose recess of the eyewear.

### Embodiment 8

The respiratory mask of Embodiment 1, wherein the concave segments of the exterior side of the body are configured to form a seal with the corresponding nose members of the eyewear.

### Embodiment 9

The respiratory mask of Embodiment 1, wherein the body is at least partially flexible.

### Embodiment 10

The respiratory mask of Embodiment 1, wherein the respiratory mask is a half mask.

### Embodiment 11

The respiratory mask of Embodiment 1, further comprising a harness configured to hold the body on the user's face.

### Embodiment 12

The respiratory mask of Embodiment 1, wherein the body comprises an opening configured to receive at least one of a filter cartridge, a valve, or an air hose therein.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1. A respirator, comprising:
an oronasal mask, the oronasal mask having a first portion configured to cover a user's mouth and a second portion (16) configured to cover a user's nose;
the second portion including an eyewear interface, the eyewear interface including:
a first side defining a first concavity; and
a second side opposite the first side, the second side defining a second concavity; and
the first concavity and the second concavity being configured to receive a nose member of corresponding eyewear.

2. The respirator of claim 1, wherein the eyewear interface defines a nose bridge receiving portion disposed between the first concavity and the second concavity, the nose bridge receiving portion being configured to receive a nose bridge of the corresponding eyewear.

3. The respirator of claim 2, wherein the nose bridge receiving portion is a recess.

4. The respirator of claim 3, wherein the nose bridge of the corresponding eyewear rests within the recess when corresponding eyewear is removably coupled to the oronasal mask.

5. The respirator of claim 3, wherein the recess is arcuate in shape along its length.

6. The respirator of claim 5, wherein the first concavity, the second concavity, and the recess cooperate to define a continuous channel.

7. The respirator of claim 1, wherein the oronasal mask includes a removable filter.

8. The respirator of claim 1, wherein the first concavity and the second concavity are configured to receive the nose member of safety goggles and safety glasses.

9. The respirator of claim 1, wherein the first concavity is entirely disposed on the first side and the second concavity is entirely disposed on the second side.

10. The respirator of claim 1, wherein when corresponding eyewear is worn by a user when wearing the respirator, the nose member of corresponding eyewear presses against the first concavity and the second cavity.

11. The respirator of claim 1, wherein the first concavity and the second concavity extend underneath the nose member when corresponding eyewear is removably coupled to the oronasal mask.

12. A respirator, comprising:
an oronasal mask, the oronasal mask having a first portion configured to cover a user's mouth and a second portion configured to cover and substantially contour a user's nose;
the second portion including an eyewear interface, the eyewear interface including a first side corresponding to a first side of a user's nose, a second side opposite the first side, and a nose bridge receiving portion disposed there between; and
the first side defining a first concavity and the second side defining a second concavity, the first concavity and the second concavity are disposed opposite from each other and are configured to receive a nose bridge and a nose member of at least one of safety goggles and safety glasses.

13. The respirator of claim 12, wherein the first concavity is entirely disposed on the first side and the second concavity is entirely disposed on the second side.

14. The respirator of claim 12, wherein when corresponding eyewear having a nose member is worn by the user when wearing the respirator, the nose member presses against the first concavity and the second concavity.

15. The respirator of claim 14, wherein the first concavity and the second concavity extend underneath the nose member when corresponding eyewear is worn by the user when wearing the respirator.

16. The respirator of claim 12, wherein the nose bridge receiving portion is a recess.

17. The respirator of claim 16, wherein the nose bridge of the corresponding eyewear rests within the recess when corresponding eyewear is worn by the user when wearing the respirator.

18. The respirator of claim 16, wherein the recess is arcuate in shape.

19. The respirator of claim 12, wherein the oronasal mask includes a removable filter.

20. A respirator, comprising:
a oronasal mask, the oronasal mask having a first portion configured to cover a user's mouth, a second portion configured to cover and substantially contour a user's nose, and a removable filter;
the second portion including an eyewear interface, the eyewear interface including a first side corresponding to a first side of a user's nose, a second side opposite the first side, and a nose bridge receiving portion disposed there between, the nose bridge receiving portion defining an arcuate recess;
the first side defining a first concavity and the second side defining a second concavity, the first concavity and the second concavity being separated from each other;
and when safety goggles having a nose bridge and a nose member are worn by a user when wearing the respirator:
the nose member presses against the first concavity and the second concavity, and the first concavity and the second cavity extend underneath the nose member; and
the nose bridge rests within the arcuate recess of the nose bridge receiving portion.
